(19) United States
(12) Patent Application Publication
(10) Pub. No.: US 2026/0247129 A1
(43) Pub. Date: Aug. 20, 2026

(54) SENSING NODE DISCOVERY METHOD, COMMUNICATION DEVICE AND STORAGE MEDIUM

(71) Applicant: BEIJING XIAOMI MOBILE SOFTWARE CO., LTD., Beijing (CN)

(72) Inventors: Jianning LIU, Beijing (CN); Yang SHEN, Beijing (CN)

(21) Appl. No.: 19/161,130

(22) PCT Filed: Mar. 3, 2023
(86) PCT No.: PCT/CN2023/079687

§ 371 Date: Aug. 29, 2025

(51) Int. Cl. H04W 8/00; H04W 8/22; H04W 12/06

(52) U.S. Cl. CPC H04W 8/005; H04W 8/22; H04W 12/06

(57) ABSTRACT

A sensing node discovery method, a communication device and a storage medium are provided. The method is performed by a first sensing node, and includes: broadcasting a discovery message to at least one second sensing node. The discovery message carries sensing capability indication information, and the sensing capability indication information indicates a sensing capability of the first sensing node. A sensing node discovery method performed by the second node includes receiving a discovery message broadcast by a first sensing node, where the discovery message carries sensing capability indication information, and the sensing capability indication information indicates a sensing capability of the first sensing node.

### CROSS-REFERENCE TO RELATED APPLICATION

The present application is a U.S. National Stage of International Application No. PCT/CN2023/079687, filed on Mar. 3, 2023, the contents of all of which are incorporated herein by reference in their entireties for all purposes.

### BACKGROUND

At present, a first terminal in a wireless communications network broadcasts a discovery message to at least one second terminal, and the discovery message carries service-related information of the first terminal, so that the discovery and interaction of the service-related information between the first terminal and the at least one second terminal may be realized.

### SUMMARY

The present disclosure relates to the field of wireless communication technologies, in particular to a sensing node discovery method, a communication device and a storage medium.

In a first aspect, embodiments of the present disclosure provide a sensing node discovery method, which is performed by a first sensing node and includes: broadcasting a discovery message to at least one second sensing node. The discovery message carries sensing capability indication information, and the sensing capability indication information indicates a sensing capability of the first sensing node.

In a second aspect, embodiments of the present disclosure provide a sensing node discovery method, which is performed by a second sensing node and includes: receiving a discovery message broadcast by a first sensing node. The discovery message carries sensing capability indication information, and the sensing capability indication information indicates a sensing capability of the first sensing node.

In a third aspect, embodiments of the present disclosure provide a communication device, which has the functions of realizing part or all of the functions of the first sensing node in the method described in the first aspect. For example, the functions of the communication device may have the functions of part or all of the embodiments in the present disclosure, or may have the function of independently implementing any one of the embodiments in the present disclosure. The functions may be realized by hardware, or by hardware executing corresponding software. The hardware or software includes one or more units or modules corresponding to the above functions.

In an implementation, the structure of the communication device may include a transceiving unit and a processing unit, and the processing unit is configured to support the communication device to perform corresponding functions in the above method. The transceiving unit is used to support communication between the communication device and other devices. The communication device may further include a storage unit for coupling with the transceiving unit and the processing unit, and storing computer programs and data necessary for the communication device.

As an example, the processing unit may be a processor, the transceiving unit may be a transceiver or a communication interface, and the storage unit may be a memory.

In a fourth aspect, embodiments of the present disclosure provide another communication device, which has the functions of realizing part or all of the functions of the second sensing node in the method described in the second aspect. For example, the functions of the communication device may have the functions of part or all of the embodiments in the present disclosure, or may have the function of independently implementing any one of the embodiments in the present disclosure. The functions may be realized by hardware, or by hardware executing corresponding software. The hardware or software includes one or more units or modules corresponding to the above functions.

In an implementation, the structure of the communication device may include a transceiving unit and a processing unit, and the processing unit is configured to support the communication device to perform corresponding functions in the above method. The transceiving unit is used to support communication between the communication device and other devices. The communication device may further include a storage unit for coupling with the transceiving unit and the processing unit, and storing computer programs and data necessary for the communication device.

As an example, the processing unit may be a processor, the transceiving unit may be a transceiver or a communication interface, and the storage unit may be a memory.

In a fifth aspect, embodiments of the present disclosure provide a communication device, which includes a processor, and when the processor calls a computer program in a memory, the method described in the first aspect is performed.

In a sixth aspect, embodiments of the present disclosure provide a communication device, which includes a processor, and when the processor calls a computer program in a memory, the method described in the second aspect is performed.

In a seventh aspect, embodiments of the present disclosure provide a communication device, which includes a processor and a memory. A computer program is stored in the memory, and the processor executes the computer program stored in the memory, to cause the communication device to perform the method described in the first aspect.

In an eighth aspect, embodiments of the present disclosure provide a communication device, which includes a processor and a memory. A computer program is stored in the memory, and the processor executes the computer program stored in the memory, to cause the communication device to perform the method described in the second aspect.

In a ninth aspect, embodiments of the present disclosure provide a communication device, which includes a processor and an interface circuit. The interface circuit is used to receive code instructions and transmit the code instructions to the processor, and the processor is used to execute the code instructions to cause the communication device to perform the method described in the first aspect.

In a tenth aspect, embodiments of the present disclosure provide a communication device, which includes a processor and an interface circuit. The interface circuit is used to receive code instructions and transmit the code instructions to the processor, and the processor is used to execute the code instructions to cause the communication device to perform the method described in the second aspect.

In an eleventh aspect, embodiments of the present disclosure provide a communication system, which includes the communication device described in the third aspect and the communication device described in the fourth aspect, or the system includes the communication device described in the fifth aspect and the communication device described in the sixth aspect, or the system includes the communication device described in the seventh aspect and the communication device described in the eighth aspect, or the system includes the communication device described in the ninth aspect and the communication device described in the tenth aspect.

In a twelfth aspect, embodiments of the present disclosure provide a computer-readable storage medium for storing instructions for the above first sensing node, which, when executed, cause the above first sensing node to perform the method described in the first aspect.

In a thirteenth aspect, embodiments of the present disclosure provide a computer-readable storage medium for storing instructions for the above second sensing node, which, when executed, cause the second sensing node to perform the method described in the second aspect.

In a fourteenth aspect, embodiments of the present disclosure further provide a computer program product including a computer program, which, when run on a computer, causes the computer to perform the method described in the first aspect.

In a fifteenth aspect, embodiments of the present disclosure further provide a computer program product including a computer program, which, when run on a computer, causes the computer to perform the method described in the second aspect.

In a sixteenth aspect, embodiments of the present disclosure provide a chip system, which includes at least one processor and an interface, for supporting the first sensing node to realize the functions involved in the first aspect, for example, determining or processing at least one of data and information involved in the above method. In a possible design, the chip system further includes a memory for storing computer programs and data necessary for the first sensing node. The chip system may be composed of chips, and may also include chips and other discrete devices.

In a seventeenth aspect, embodiments of the present disclosure provide a chip system, which includes at least one processor and an interface, for supporting the second sensing node to realize the functions involved in the second aspect, for example, determining or processing at least one of data and information involved in the above method. In a possible design, the chip system further includes a memory for storing computer programs and data necessary for the second sensing node. The chip system may be composed of chips, and may also include chips and other discrete devices.

In an eighteenth aspect, embodiments of the present disclosure provide a computer program which, when run on a computer, causes the computer to perform the method described in the first aspect.

In a nineteenth aspect, embodiments of the present disclosure provide a computer program which, when run on a computer, causes the computer to perform the method described in the second aspect.

### BRIEF DESCRIPTION OF THE DRAWINGS

In order to more clearly explain the technical scheme in the embodiments of the present disclosure or the related art, the drawings needed in the embodiments of the present disclosure or the related art will be explained below.

FIG. 1 is a schematic architecture diagram of a communication system provided by an embodiment of the present disclosure.

FIG. 2 is a schematic diagram of a short-range discovery mechanism based on mode A provided by an embodiment of the present disclosure.

FIG. 3 is a flowchart of a sensing node discovery method performed by a first sensing node provided by an embodiment of the present disclosure.

FIG. 4 is a flowchart of another sensing node discovery method provided by an embodiment of the present disclosure.

FIG. 5 is a flowchart of a sensing node discovery method performed by a second sensing node provided by an embodiment of the present disclosure.

FIG. 6 is a flowchart of another sensing node discovery method provided by an embodiment of the present disclosure.

FIG. 7 is a schematic block diagram of a communication device provided by an embodiment of the present disclosure.

FIG. 8 is a schematic block diagram of another communication device provided by an embodiment of the present disclosure.

FIG. 9 is a schematic block diagram of a chip provided by an embodiment of the present disclosure.

### DETAILED DESCRIPTION

In order to better understand a sensing node discovery method and device provided in the embodiments of the present disclosure, a communication system applicable to the embodiments of the present disclosure will be described below.

FIG. 1 is a schematic diagram of a communication system provided by an embodiment of the present disclosure. The communication system may include, but is not limited to, a network device and a terminal. The number and form of devices shown in FIG. 1 are only illustrative and do not constitute a limitation to the embodiments of the present disclosure. In practical applications, two or more network devices and two or more terminals may be included. The communication system shown in FIG. 1 includes one network device 101 and one terminal 102, for example.

It should be noted that the technical scheme of the embodiments of the present disclosure may be applied to various communication systems, for example, a long term evolution (LTE) system, a 5th generation (5G) mobile communication system, a 5G new radio (NR) system, or other new mobile communication systems in the future.

The network device 101 in the embodiments of the present disclosure is an entity on a network side for transmitting or receiving signals. For example, the network device 101 may be an evolved NodeB (eNB), a transmission reception point (TRP), a next generation NodeB (gNB) in the NR system, base stations in other future mobile communication systems or an access node in a wireless networking (Wi-Fi™) system. The embodiments of the present disclosure do not limit the specific technology and the specific device form adopted by the network device. The network device provided by the embodiments of the present disclosure may be composed of a central unit (CU) and a distributed unit (DU). The CU may also be called a control unit. With the CU-DU structure, the protocol layers of the network device, such as the base station, may be separated, so that the functions of some protocol layers are centrally controlled by the CU, while the functions of some or all of the remaining protocol layers are distributed in the DU, and the DU is centrally controlled by the CU.

The terminal 102 in the embodiments of the present disclosure is an entity on a user side for receiving or transmitting signals, such as a mobile phone. The terminal may also be called a terminal device, user equipment (UE), a mobile station (MS), a mobile terminal (MT) and so on. The terminal may be a vehicle with a communication function, a smart vehicle, a mobile phone, a wearable device, a Pad, a computer with a wireless transceiving function, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in a smart city, a wireless terminal in smart home, etc. The embodiments of the present disclosure do not limit the specific technology and the specific device form adopted by the terminal.

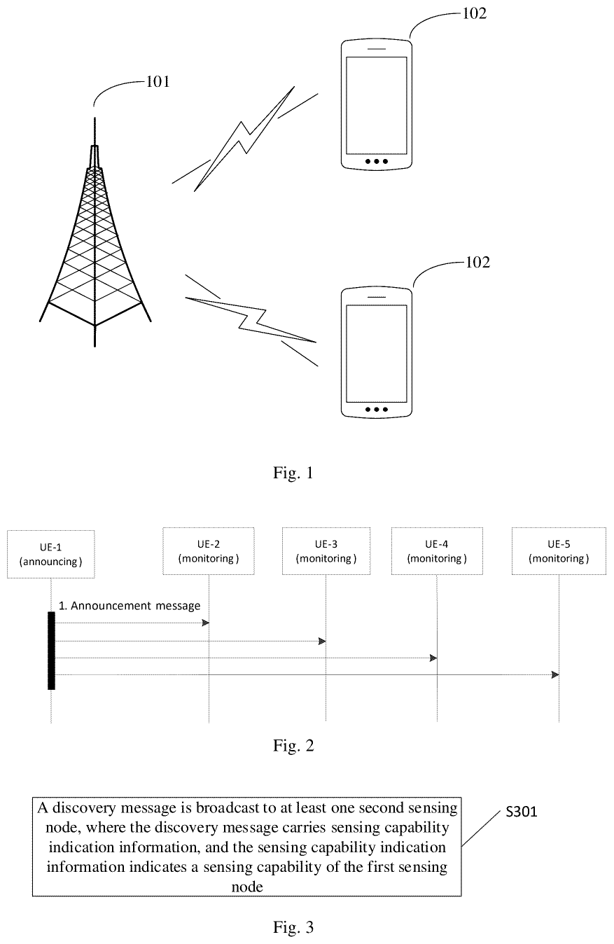

At present, a short-range discovery mechanism based on mode A is that a first terminal broadcasts a discovery message to at least one second terminal, and the discovery message carries service-related information of the first terminal; in a case that the second terminal is interested in a service indicated in the discovery message, it may further communicate with the first terminal through a communication mechanism to use the service provided by the first terminal. FIG. 2 is a schematic diagram of the short-range discovery mechanism based on mode A. In FIG. 2, UE-1 (first terminal) broadcasts an announcement message to UE-2 to UE-5 (second terminal).

However, there is currently no discovery scheme of a sensing capability between the first terminal and the at least one second terminal.

It should also be noted that a first sensing node and a second sensing node in the embodiments of the present disclosure are terminals with sensing capabilities.

It may be understood that the communication system described in the embodiments of the present disclosure is for more clearly explaining the technical scheme of the embodiments of the present disclosure, and does not constitute a limitation on the technical scheme provided by the embodiments of the present disclosure. As those ordinary skilled in the related art know, with the evolution of the system architecture and the emergence of new service scenarios, the technical scheme provided by the embodiments of the present disclosure is also applicable to similar technical problems.

It should be noted that the first sensing node mentioned in any one of the embodiments of the present disclosure is a terminal that has a sensing capability and broadcasts a discovery message, for example, it may refer to the terminal 102 in the communication system shown in FIG. 1, or it may refer to the UE-1 shown in FIG. 2. The second sensing node mentioned in any one of the embodiments of the present disclosure is a terminal that has a sensing capability and receives the discovery message, for example, it may refer to the terminal 102 in the communication system shown in FIG. 1, or it may refer to the UE-2 to the UE-5 shown in FIG. 2.

It should be noted that the sensing node discovery method provided by any one of the embodiments of the present disclosure may be performed alone, or in combination with possible implementation methods in other embodiments, or in combination with any technical scheme in the related art.

In the following, the sensing node discovery method and device provided by the present disclosure will be introduced in detail with reference to the accompanying drawings.

FIG. 3 is a flowchart of a sensing node discovery method provided by an embodiment of the present disclosure. The sensing node discovery method is performed by a first sensing node. As shown in FIG. 3, the method may include, but is not limited to, the following step.

In step S301, a discovery message is broadcast to at least one second sensing node, where the discovery message carries sensing capability indication information, and the sensing capability indication information indicates a sensing capability of the first sensing node.

In the embodiment of the present disclosure, the first sensing node may refer to a terminal that has the sensing capability and broadcasts the discovery message. The second sensing node may refer to a terminal that has the sensing capability and receives the discovery message. In a case that a terminal with the sensing capability only broadcasts the discovery message during the discovery process, the terminal may be the first sensing node. In a case that a terminal with the sensing capability only receives the discovery message during the discovery process, the terminal may be the second sensing node. In a case that a terminal with the sensing capability broadcasts the discovery message and receives other discovery messages during the discovery process, the terminal may be both the first sensing node and the second sensing node. In a case that the terminal is both the first sensing node and the second sensing node, the discovery message broadcast when the terminal serves as the first sensing node is different from the discovery message received when the terminal serves as the second sensing node.

In the embodiment of the present disclosure, the sensing capability indication information may indicate at least one of the following sensing capabilities: a sensing transmission capability, a sensing reception capability and a sensing data processing capability. The sensing transmission capability may refer to a sensing signal transmission capability. The sensing signal transmission capability means that the sensing node has a capability to transmit a sensing signal. The sensing signal, such as a radar signal, a laser signal and an electromagnetic wave signal, may be a signal used for a parameter measurement of an object or an area, and may be set according to actual needs.

The sensing reception capability may refer to a sensing signal reception capability. The sensing signal reception capability means that the sensing node has a capability to receive the sensing signal. In addition, in some embodiments, the sensing reception capability may also include a capability to process the received sensing signal.

The sensing data processing capability may refer to a sensing signal processing capability. The sensing signal processing capability means that the sensing node has a capability to process the sensing signal.

In the embodiment of the present disclosure, the sensing capability of the first sensing node may be determined by a hardware device of the first sensing node, or determined through negotiation between the first sensing node and a network device. In a first example, the sensing capability of the first sensing node may be determined by the hardware device of the first sensing node. In a second example, the sensing capability of the first sensing node may be determined through the negotiation between the first sensing node and the network device.

In the first example, that the sensing capability of the first sensing node is determined by the hardware device of the first sensing node means that the hardware device of the first sensing node has been preconfigured with its sensing capabilities before leaving the factory.

In the second example, the way in which the first sensing node negotiates with the network device to determine the sensing capability includes: the first sensing node reports a possessed sensing capability to the network device, and the possessed sensing capability is determined by the hardware device of the first sensing node; and feedback information of the network device is received, where the feedback information indicates a sensing capability authorized by the network device or a sensing capability supported by the network device.

In the second example, the network device may determine the authorized or supported sensing capability by combining the sensing capability possessed by the first sensing node and at least one of the following information: subscription information of a user corresponding to the first sensing node and network device policy information. In an example, the network device may determine the sensing capability authorized by the network device or the sensing capability supported by the network device by combining the sensing capability possessed by the first sensing node with the subscription information of the user corresponding to the first sensing node. In another example, the network device may determine the sensing capability authorized by the network device or the sensing capability supported by the network device by combining the sensing capability possessed by the first sensing node with the network device policy information. In yet another example, the network device may determine the sensing capability authorized by the network device or the sensing capability supported by the network device by combining the sensing capability possessed by the first sensing node with the subscription information of the user corresponding to the first sensing node and the network device policy information.

It should be noted that the sensing capability authorized by the network device or the sensing capability supported by the network device may be at least one of the sensing capabilities determined by the hardware device of the first sensing node.

In the embodiment of the present disclosure, the discovery message may further carry at least one of the following information besides the sensing capability indication information: a source layer 2 address; a target layer 2 address; a discovery message type; a designated code indicating a service; and a security protection element.

The source layer 2 address and the target layer 2 address may be configured by the network device or by the first sensing node. The source layer 2 address is a layer 2 address owned by the first sensing node. The target layer 2 address is a layer 2 address that the second sensing node configured to receive the discovery message needs to have. That is, in a case that one second sensing node has the target layer 2 address, it may receive the discovery message; and in a case that one second sensing node does not have the target layer 2 address, it may ignore the discovery message, or discard the received discovery message.

The discovery message may include multiple target layer 2 addresses. In a case that the multiple target layer 2 addresses are included, in an example, the multiple target layer 2 addresses may be configured by the network device; in another example, the multiple target Layer 2 addresses may be configured by the first sensing node; and in yet another example, part of the multiple target layer 2 addresses may be configured by the network device, and other parts of the multiple target layer 2 addresses may be configured by the first sensing node.

The discovery message type includes for example at least one of: direct discovery, discovery between the terminals (UE to UE discovery), discovery between the terminal and the network device (UE to network discovery), and so on. In the embodiment of the present disclosure, the discovery process of the sensing node adopts the discovery mechanism based on mode A, and thus the discovery message type may be the direct discovery.

The designated code (ProSe application code or ProSe restricted code) indicating the service refers to the application code related to the service. Different application codes indicate different services. The second sensing node may determine the service provided by the first sensing node according to the application code, and then communicate with the first sensing node to use the service provided by the first sensing node when interested in the service.

The security protection element refers to a parameter needed to establish a secure connection. In combination with the security protection element, a secure connection between the first sensing node and the second sensing node may be established.

In the sensing node discovery method provided by the embodiment of the present disclosure, the first sensing node may broadcast the discovery message to the at least one second sensing node, and the discovery message carries the sensing capability indication information for indicating the sensing capability of the first sensing node, so that the sensing capability discovery between the first sensing node and the second sensing node is realized, and it is convenient for the sensing nodes to use the sensing capabilities provided by other sensing nodes.

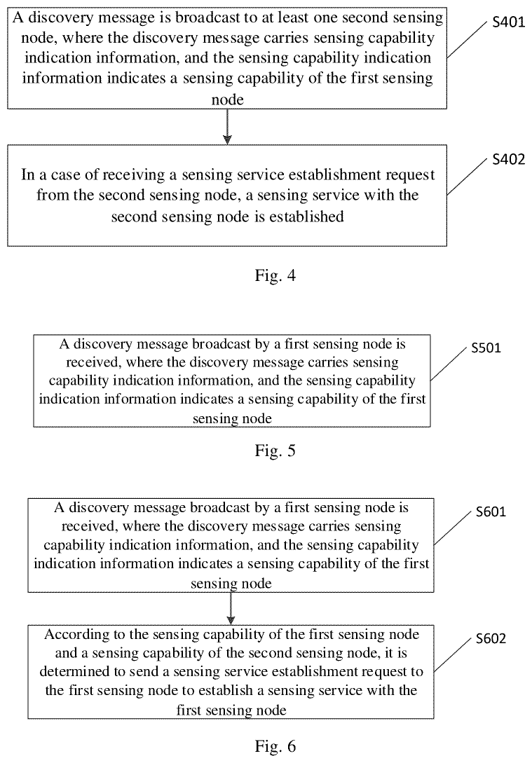

FIG. 4 is a flowchart of another sensing node discovery method provided by an embodiment of the present disclosure. The sensing node discovery method is performed by a first sensing node. As shown in FIG. 4, the method may include, but is not limited to, the following steps.

In step S401, a discovery message is broadcast to at least one second sensing node, where the discovery message carries sensing capability indication information, and the sensing capability indication information indicates a sensing capability of the first sensing node.

In step S402, in a case of receiving a sensing service establishment request from the second sensing node, a sensing service with the second sensing node is established.

In the embodiment of the present disclosure, the second sensing node that sends the sensing service establishment request to the first sensing node may be a sensing node that needs to use the sensing capability of the first sensing node. There may be two cases in which the second sensing node needs to use the sensing capability of the first sensing node. In a case, the second sensing node needs to use all the sensing capabilities of the first sensing node. In another case, the second sensing node needs to use part of the sensing capabilities of the first sensing node.

In the embodiment of the present disclosure, after the sensing service is established between the first sensing node and the second sensing node, in the sensing service, the sensing capability provided by the first sensing node and the sensing capability provided by the second sensing node may include any one of the following cases: the first sensing node provides a sensing transmission capability, and the second sensing node provides a sensing reception capability and a sensing data processing capability; the first sensing node provides a sensing transmission capability and a sensing reception capability, and the second sensing node provides a sensing data processing capability; the first sensing node provides a sensing reception capability and a sensing data processing capability, and the second sensing node provides a sensing transmission capability; the first sensing node provides a sensing data processing capability, and the second sensing node provides a sensing transmission capability and a sensing reception capability.

In a case that the first sensing node provides the sensing transmission capability and the second sensing node provides the sensing reception capability and the sensing data processing capability, in the sensing service, the first sensing node may transmit a sensing signal to a target object or a target area; and the second sensing node may receive the sensing signal reflected by the target object or target area, and process the sensing data (parameter information of the reflected sensing signal and parameter information of the transmitted sensing signal provided by the first sensing node, etc.) to obtain parameter data of the target object or target area, etc.

In a case that the first sensing node provides the sensing transmission capability and the sensing reception capability and the second sensing node provides the sensing data processing capability, in the sensing service, the first sensing node may transmit a sensing signal to a target object or target area, and receive the sensing signal reflected by the target object or target area; and the second sensing node may process the sensing data (parameter information of the reflected sensing signal and parameter information of the transmitted sensing signal provided by the first sensing node, etc.).

In a case that the first sensing node provides the sensing reception capability and the sensing data processing capability and the second sensing node provides the sensing transmission capability, in the sensing service, the second sensing node may transmit a sensing signal to a target object or target area; and the first sensing node may receive the sensing signal reflected by the target object or target area, and process the sensing data (parameter information of the reflected sensing signal and parameter information of the transmitted sensing signal provided by the second sensing node, etc.) to obtain parameter data of the target object or target area, etc.

In a case that the first sensing node provides the sensing data processing capability and the second sensing node provides the sensing transmission capability and the sensing reception capability, in the sensing service, the second sensing node may transmit a sensing signal to a target object or target area, and receive the sensing signal reflected by the target object or target area; and the first sensing node may process the sensing data (parameter information of the reflected sensing signal and parameter information of the transmitted sensing signal provided by the second sensing node, etc.).

According to the sensing node discovery method provided in the embodiment of the present disclosure, the first sensing node may broadcast the discovery message to the at least one second sensing node, where the discovery message carries the sensing capability indication information, and the sensing capability indication information indicates the sensing capability of the first sensing node; and in a case of receiving the sensing service establishment request from the second sensing node, the sensing service with the second sensing node is established, so that the sensing capability discovery between the first sensing node and the second sensing node is realized, and it is convenient for the sensing nodes to use the sensing capabilities provided by other sensing nodes.

FIG. 5 is a flowchart of a sensing node discovery method provided by an embodiment of the present disclosure. The sensing node discovery method is performed by a second sensing node. As shown in FIG. 5, the method may include, but is not limited to, the following step.

In step S501, a discovery message broadcast by a first sensing node is received, where the discovery message carries sensing capability indication information, and the sensing capability indication information indicates a sensing capability of the first sensing node.

In the embodiment of the present disclosure, the first sensing node may refer to a terminal that has the sensing capability and broadcasts the discovery message. The second sensing node may refer to a terminal that has the sensing capability and receives the discovery message. In a case that a terminal with the sensing capability only broadcasts the discovery message during the discovery process, the terminal may be the first sensing node. In a case that a terminal with the sensing capability only receives the discovery message during the discovery process, the terminal may be the second sensing node. In a case that a terminal with the sensing capability broadcasts the discovery message and receives other discovery messages during the discovery process, the terminal may be both the first sensing node and the second sensing node. In a case that the terminal is both the first sensing node and the second sensing node, the discovery message broadcast when the terminal serves as the first sensing node is different from the discovery message received when the terminal serves as the second sensing node.

In the embodiment of the present disclosure, the sensing capability indication information may indicate at least one of the following sensing capabilities: a sensing transmission capability, a sensing reception capability and a sensing data processing capability. The sensing transmission capability may refer to a sensing signal transmission capability. The sensing signal transmission capability means that the sensing node has a capability to transmit a sensing signal. The sensing signal, such as a radar signal, a laser signal and an electromagnetic wave signal, may be a signal used for a parameter measurement of an object or an area, and may be set according to actual needs.

The sensing reception capability may refer to a sensing signal reception capability. The sensing signal reception capability means that the sensing node has a capability to receive the sensing signal. In addition, in some embodiments, the sensing reception capability may also include a capability to process the received sensing signal.

The sensing data processing capability may refer to a sensing signal processing capability. The sensing signal processing capability means that the sensing node has a capability to process the sensing signal.

In the embodiment of the present disclosure, the discovery message may further carry at least one of the following information besides the sensing capability indication information: a source layer 2 address; a target layer 2 address; a discovery message type; a designated code indicating a service; and a security protection element.

The source layer 2 address is a layer 2 address owned by the first sensing node. The target layer 2 address is a layer 2 address that the second sensing node configured to receive the discovery message needs to have. That is, in a case that one second sensing node has the target layer 2 address, it may receive the discovery message; and in a case that one second sensing node does not have the target layer 2 address, it may ignore the discovery message, or discard the received discovery message.

The discovery message may include multiple target layer 2 addresses. The discovery message type includes for example at least one of: direct discovery, discovery between the terminals (UE to UE discovery), discovery between the terminal and the network device (UE to network discovery), and so on. In the embodiment of the present disclosure, the discovery process of the sensing node adopts the discovery mechanism based on mode A, and thus the discovery message type may be the direct discovery.

The designated code (ProSe application code or ProSe restricted code) indicating the service refers to the application code related to the service. Different application codes indicate different services. The second sensing node may determine the service provided by the first sensing node according to the application code, and then communicate with the first sensing node to use the service provided by the first sensing node when interested in the service.

The security protection element refers to a parameter needed to establish a secure connection. In combination with the security protection element, a secure connection between the first sensing node and the second sensing node may be established.

In the sensing node discovery method provided in the embodiment of the present disclosure, the second sensing node may receive the discovery message broadcast by the first sensing node, where the discovery message carries the sensing capability indication information, and the sensing capability indication information indicates the sensing capability of the first sensing node, thereby realizing the sensing capability discovery between the first sensing node and the second sensing node, and facilitating the sensing nodes to use the sensing capabilities provided by other sensing nodes.

FIG. 6 is a flowchart of another sensing node discovery method provided by an embodiment of the present disclosure. The sensing node discovery method is performed by a second sensing node. As shown in FIG. 6, the method may include, but is not limited to, the following steps.

In step S601, a discovery message broadcast by a first sensing node is received, where the discovery message carries sensing capability indication information, and the sensing capability indication information indicates a sensing capability of the first sensing node.

In the embodiment of the present disclosure, after step S601, the second sensing node may also perform the following process: in a case that a target layer 2 address carried in the discovery message does not match a target layer 2 address field of the second sensing node, the discovery message is discarded.

In addition, in a case that the target layer 2 address carried in the discovery message matches the target layer 2 address field of the second sensing node, the above operation is not performed.

The process for the second sensing node to determine whether the target layer 2 address carried in the discovery message matches the target layer 2 address field of the second sensing node may include, for example: it is determined that the target layer 2 address matches the target layer 2 address field in a case that the target layer 2 address is included in the target layer 2 address field; and it is determined that the target layer 2 address does not match the target layer 2 address field in a case that the target layer 2 address is not included in the target layer 2 address field.

In the embodiment of the present disclosure, the target layer 2 address field may be configured by the second sensing node.

In step S602, according to the sensing capability of the first sensing node and a sensing capability of the second sensing node, it is determined to send a sensing service establishment request to the first sensing node to establish a sensing service with the first sensing node.

In the embodiment of the present disclosure, the sensing capability of the second sensing node may be determined by a hardware device of the second sensing node, or determined through negotiation between the second sensing node and a network device. In a first example, the sensing capability of the second sensing node may be determined by the hardware device of the second sensing node. In a second example, the sensing capability of the second sensing node may be determined through the negotiation between the second sensing node and the network device.

In the first example, that the sensing capability of the second sensing node is determined by the hardware device of the second sensing node means that the hardware device of the second sensing node has been preconfigured with its sensing capabilities before leaving the factory.

In the second example, the way in which the second sensing node negotiates with the network device to determine the sensing capability of the second sensing node includes: reporting a possessed sensing capability to the network device, where the possessed sensing capability is determined by the hardware device of the second sensing node; and receiving feedback information of the network device, where the feedback information indicates a sensing capability authorized by the network device or a sensing capability supported by the network device.

In the second example, the network device may determine the authorized or supported sensing capability by combining the sensing capability possessed by the second sensing node and at least one of the following information: subscription information of a user corresponding to the second sensing node and network device policy information. In an example, the network device may determine the sensing capability authorized by the network device or the sensing capability supported by the network device by combining the sensing capability possessed by the second sensing node with the subscription information of the user corresponding to the second sensing node. In another example, the network device may determine the sensing capability authorized by the network device or the sensing capability supported by the network device by combining the sensing capability possessed by the second sensing node with the network device policy information. In yet another example, the network device may determine the sensing capability authorized by the network device or the sensing capability supported by the network device by combining the sensing capability possessed by the second sensing node with the subscription information of the user corresponding to the second sensing node and the network device policy information.

It should be noted that the sensing capability authorized by the network device or the sensing capability supported by the network device may be at least one of the sensing capabilities determined by the hardware device of the second sensing node.

In the embodiment of the present disclosure, in a case that the first sensing node and the second sensing node meet any one of the following conditions, the second sensing node determines to send the sensing service establishment request to the first sensing node: the first sensing node has a sensing transmission capability and the second sensing node has a sensing reception capability and a sensing data processing capability; the first sensing node has a sensing transmission capability and a sensing reception capability, and the second sensing node has a sensing data processing capability; the first sensing node has a sensing reception capability and a sensing data processing capability, and the second sensing node has a sensing transmission capability; and the first sensing node has a sensing data processing capability, and the second sensing node has a sensing transmission capability and a sensing reception capability.

That is, the second sensing node determines to send the sensing service establishment request to the first sensing node when the sensing capability of the first sensing node needs to be used. The second sensing node determines not to send the sensing service establishment request to the first sensing node when the sensing capability of the first sensing node does not need to be used.

In the embodiment of the present disclosure, after the sensing service is established between the first sensing node and the second sensing node, in the sensing service, the sensing capability provided by the first sensing node and the sensing capability provided by the second sensing node may include any one of the following cases: the first sensing node provides a sensing transmission capability, and the second sensing node provides a sensing reception capability and a sensing data processing capability; the first sensing node provides a sensing transmission capability and a sensing reception capability, and the second sensing node provides a sensing data processing capability; the first sensing node provides a sensing reception capability and a sensing data processing capability, and the second sensing node provides a sensing transmission capability; the first sensing node provides a sensing data processing capability, and the second sensing node provides a sensing transmission capability and a sensing reception capability.

In a case that the first sensing node provides the sensing transmission capability and the second sensing node provides the sensing reception capability and the sensing data processing capability, in the sensing service, the first sensing node may transmit a sensing signal to a target object or a target area; and the second sensing node may receive the sensing signal reflected by the target object or target area, and process the sensing data (parameter information of the reflected sensing signal and parameter information of the transmitted sensing signal provided by the first sensing node, etc.) to obtain parameter data of the target object or target area, etc.

In a case that the first sensing node provides the sensing transmission capability and the sensing reception capability and the second sensing node provides the sensing data processing capability, in the sensing service, the first sensing node may transmit a sensing signal to a target object or target area, and receive the sensing signal reflected by the target object or target area; and the second sensing node may process the sensing data (parameter information of the reflected sensing signal and parameter information of the transmitted sensing signal provided by the first sensing node, etc.).

In a case that the first sensing node provides the sensing reception capability and the sensing data processing capability and the second sensing node provides the sensing transmission capability, in the sensing service, the second sensing node may transmit a sensing signal to a target object or target area; and the first sensing node may receive the sensing signal reflected by the target object or target area, and process the sensing data (parameter information of the reflected sensing signal and parameter information of the transmitted sensing signal provided by the second sensing node, etc.) to obtain parameter data of the target object or target area, etc.

In a case that the first sensing node provides the sensing data processing capability and the second sensing node provides the sensing transmission capability and the sensing reception capability, in the sensing service, the second sensing node may transmit a sensing signal to a target object or target area, and receive the sensing signal reflected by the target object or target area; and the first sensing node may process the sensing data (parameter information of the reflected sensing signal and parameter information of the transmitted sensing signal provided by the second sensing node, etc.).

In the sensing node discovery method provided in the embodiment of the present disclosure, the second sensing node may receive the discovery message broadcast by the first sensing node, where the discovery message carries the sensing capability indication information, and the sensing capability indication information indicates the sensing capability of the first sensing node. According to the sensing capabilities of the first sensing node and the second sensing node, it is determined to send the sensing service establishment request to the first sensing node to establish the sensing service with the first sensing node, thereby realizing the sensing capability discovery between the first sensing node and the second sensing node, and facilitating the sensing nodes to use the sensing capabilities provided by other sensing nodes.

The following is a specific example of the above sensing node discovery method of the present disclosure.

In step 0, sensing node 1 (first sensing node), sensing node 2 (second sensing node) and sensing node 3 (second sensing node) are preconfigured with necessary parameters/authorization policies for sensing services by the network device, which include the sensing capabilities, such as the sensing transmission capability, the sensing reception capability, the sensing data processing capability, and the like.

The sensing transmission capability indicates that the sensing node may transmit the sensing signal, the sensing reception capability indicates that the sensing node may receive the sensing signal, and the sensing data processing capability indicates that the sensing node may process the sensing signal.

In step 1, the sensing node 1 broadcasts the discovery message. The discovery message may include the type of the discovery message, the ProSe application code or the ProSe restricted code, the security protection element, [metadata information], and the sensing capability. The application layer metadata information may be sent as metadata information in the announcement message. The sensing capability may include the sensing transmission capability, the sensing reception capability, the sensing data processing capability, etc.

In step 2, the sensing node 2 determines to trigger the sensing service based on the discovery message received from other sensing nodes (the sensing node 1) in step 1 and the sensing capability of the sensing node 1 (if necessary). For example, when the sensing node 2 only supports the sensing transmission capability, other sensing nodes with the sensing reception capability and the sensing data processing capability need to be selected to establish the sensing service. The sensing node 2 determines a target layer 2 ID (target layer 2 address) for signaling reception. The target layer 2 ID is configured in the sensing node.

In step 3, the sensing node 2 sends the sensing service establishment request to the selected sensing node 1.

The following is a specific example of the sensing service process after the above sensing node discovery process of the present disclosure.

It is assumed that the sensing node 1 provides the sensing transmission capability and the sensing node 2 provides the sensing reception capability and the sensing data processing capability. It is assumed that the sensing signal is the radar signal.

In step 0, the sensing node 1 interacts with the sensing node 2 to determine transmission parameters of the radar signal, such as a transmission direction, a transmission power, a working frequency, a transmission time and the like, in combination with the target object or target area.

In step 1, the sensing node 1 transmits the radar signal to the target object or target area according to the transmission parameters of the radar signal.

In step 2, the sensing node 2 receives the radar signal reflected by the target object or target area.

In step 3, the sensing node 2 processes the sensing data (parameter information of the reflected radar signal and parameter information of the transmitted radar signal provided by the sensing node 1, etc.) to determine the parameter data of the target object or target area, etc.

In the above embodiments provided by the present disclosure, the methods provided by the embodiments of the present disclosure are introduced from the perspectives of the first sensing node and the second sensing node respectively. In order to realize the functions in the methods provided by the embodiments of the present disclosure, the first sensing node and the second sensing node may include a hardware structure and a software module, and the above functions are realized in the form of the hardware structure, the software module, or the hardware structure plus the software module. A certain one of the above functions may be implemented by means of the hardware structure, the software module, or a combination of the hardware structure and the software module.

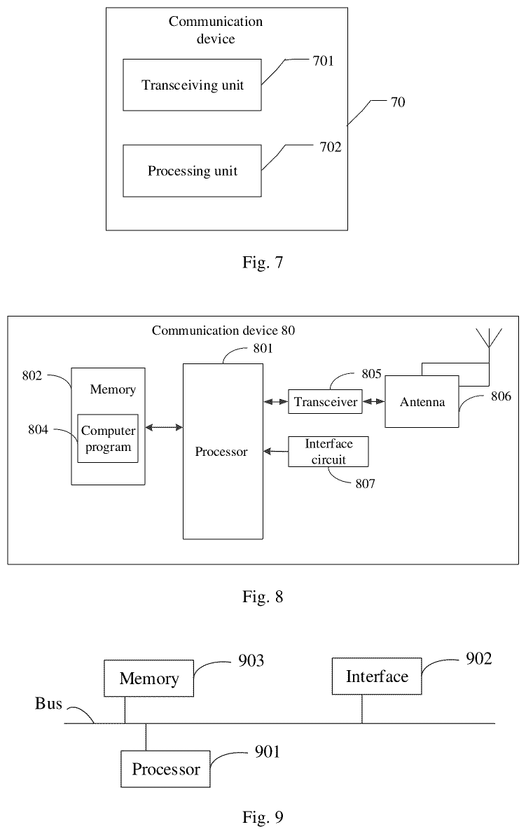

FIG. 7 is a schematic block diagram of a communication device 70 provided by an embodiment of the present disclosure. The communication device 70 shown in FIG. 7 may include a transceiving unit 701 and a processing unit 702. The transceiving unit 701 may include a transmitting unit and/or a receiving unit, the transmitting unit is used for realizing a transmitting function and the receiving unit is used for realizing a receiving function, so that the transceiving unit 701 may realize the transmitting function and/or the receiving function.

The communication device 70 may be a terminal (such as the first sensing node or the second sensing node in the aforementioned method embodiments), a device in the terminal, or a device that may be used in conjunction with the terminal.

In a case that the communication device 70 is the terminal (such as the first sensing node in the aforementioned method embodiments), the transceiving unit 701 is configured to broadcast a discovery message to at least one second sensing node, where the discovery message carries sensing capability indication information, and the sensing capability indication information indicates a sensing capability of the first sensing node.

In some embodiments, the sensing capability indication information indicates at least one of the following sensing abilities: a sensing transmission capability, a sensing reception capability and a sensing data processing capability.

In some embodiments, the sensing capability of the first sensing node is determined by a hardware device of the first sensing node, or is determined through negotiation between the first sensing node and the network device.

In some embodiments, a way in which the first sensing node negotiates with the network device to determine the sensing capability includes: reporting a possessed sensing capability to the network device, and the possessed sensing capability is determined by the hardware device of the first sensing node; and receiving feedback information of the network device, where the feedback information indicates a sensing capability authorized by the network device or a sensing capability supported by the network device.

In some embodiments, the discovery message further carries at least one of: a source layer 2 address; a target layer 2 address; a discovery message type; a designated code indicating a service; and a security protection element.

In some embodiments, the source layer 2 address and the target layer 2 address are configured by the network device or by the first sensing node.

In some embodiments, the processing unit 702 is configured to establish a sensing service with the second sensing node in a case of receiving a sensing service establishment request from the second sensing node.

In a case that the communication device 70 is the terminal (such as the second sensing node in the aforementioned method embodiments), the transceiving unit 701 is configured to receive a discovery message broadcast by a first sensing node, where the discovery message carries sensing capability indication information, and the sensing capability indication information indicates a sensing capability of the first sensing node.

In some embodiments, the sensing capability indication information indicates at least one of the following sensing abilities: a sensing transmission capability, a sensing reception capability and a sensing data processing capability.

In some embodiments, the discovery message further carries at least one of: a source layer 2 address; a target layer 2 address; a discovery message type; a designated code indicating a service; and a security protection element.

In some embodiments, the processing unit 702 is configured to discard the discovery message in a case that a target layer 2 address carried in the discovery message does not match a target layer 2 address field of the second sensing node.

In some embodiments, the target layer 2 address field of the second sensing node is configured by the second sensing node.

In some embodiments, the processing unit 702 is further configured to determine to send a sensing service establishment request to the first sensing node according to the sensing capability of the first sensing node and a sensing capability of the second sensing node, so as to establish a sensing service with the first sensing node.

In some embodiments, the sensing capability of the second sensing node is determined by a hardware device of the second sensing node, or is determined through negotiation between the second sensing node and the network device.

In some embodiments, a way in which the second sensing node negotiates with the network device to determine the sensing capability includes: reporting a possessed sensing capability to the network device, where the possessed sensing capability is determined by the hardware device of the second sensing node; and receiving feedback information of the network device, where the feedback information indicates a sensing capability authorized by the network device or a sensing capability supported by the network device.

In some embodiments, in a case that the first sensing node and the second sensing node meet any one of the following conditions, it is determined to send the sensing service establishment request to the first sensing node: the first sensing node has a sensing transmission capability and the second sensing node has a sensing reception capability and a sensing data processing capability; the first sensing node has a sensing transmission capability and a sensing reception capability, and the second sensing node has a sensing data processing capability; the first sensing node has a sensing reception capability and a sensing data processing capability, and the second sensing node has a sensing transmission capability; and the first sensing node has a sensing data processing capability, and the second sensing node has a sensing transmission capability and a sensing reception capability.

FIG. 8 is a schematic block diagram of another communication device 80 provided by an embodiment of the present disclosure. The communication device 80 may be a terminal (such as the first sensing node or the second sensing node in the aforementioned method embodiments), or a chip, a chip system, or a processor that supports the terminal to realize the above methods. The device may be used to realize the methods described in the above method embodiments, and for details, reference may be made to the descriptions in the above method embodiments.

The communication device 80 may include one or more processors 801. The processor 801 may be a general-purpose processor or a special-purpose processor or the like, for example, a baseband processor or a central processor. The baseband processor may be used to process communication protocols and communication data, and the central processor may be used to control the communication device (such as a base station, a baseband chip, a terminal, a terminal chip, a DU or a CU, etc.), execute computer programs, and process data of computer programs.

In some embodiments, the communication device 80 may further include one or more memories 802, on which a computer program 804 may be stored, and the processor 801 executes the computer program 804, so that the communication device 80 may perform the methods described in the above method embodiments. In some embodiments, data may also be stored in the memory 802. The communication device 80 and the memory 802 may be arranged separately or integrated together.

In some embodiments, the communication device 80 may further include a transceiver 805 and an antenna 806. The transceiver 805 may be called a transceiving unit, a transceiver, a transceiving circuit, etc., and is used to realize a transceiving function. The transceiver 805 may include a receiver and a transmitter, the receiver may be called a receiving machine or a receiving circuit, etc., and is used to realize a receiving function, and the transmitter may be called a transmitting machine or a transmitting circuit, etc., and is used to realize a transmitting function.

In some embodiments, the communication device 80 may further include one or more interface circuits 807. The interface circuit 807 is used to receive code instructions and transmit them to the processor 801. The processor 801 executes the code instructions to cause the communication device 80 to perform the methods described in the above method embodiments.

In a case that the communication device 80 is a terminal (such as the first sensing node in the aforementioned method embodiments), the processor 801 is used to execute step S402 in FIG. 4. The transceiver 805 is configured to execute step S301 in FIG. 3 and step S401 in FIG. 4.

In a case that the communication device 80 is a terminal (such as the second sensing node in the aforementioned method embodiments), the transceiver 805 is used to execute step S501 in FIG. 5 and step S601 in FIG. 6. The processor 801 is used to execute step S602 in FIG. 6.

In an implementation, the processor 801 may include a transceiver for receiving and transmitting functions. For example, the transceiver may be a transceiving circuit, or an interface, or an interface circuit. The transceiving circuits, interfaces or interface circuits for receiving and transmitting functions may be separated or integrated. The transceiving circuit, interface or interface circuit may be used for reading and writing codes/data, or the transceiving circuit, interface or interface circuit may be used for signal transmission or transfer.

In an implementation, the processor 801 may store a computer program 803, and the computer program 803 runs on the processor 801, which may cause the communication device 80 to perform the methods described in the above method embodiments. The computer program 803 may be embedded in the processor 801, in which case, the processor 801 may be implemented by hardware.

In an implementation, the communication device 80 may include a circuit, which may realize the function of transmitting or receiving or communicating in the aforementioned method embodiments. The processor and transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, and the like. The processor and transceiver may also be manufactured by various IC process technologies, such as complementary metal oxide semiconductor (CMOS), negative channel metal oxide semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication device described in the above embodiments may be a network device or a terminal (such as the first sensing node or the second sensing node in the aforementioned method embodiments), but the scope of the communication device described in the present disclosure is not limited to this, and the structure of the communication device may not be limited by FIG. 8. The communication device may be a stand-alone device or may be part of a large device. For example, the communication device may be:
(1) an independent integrated circuit IC, or a chip, or a chip system or subsystem;
(2) a set of one or more ICs, for example, the IC set may also include storage components for storing data and computer programs;
(3) an ASIC, such as a modem;
(4) a module that may be embedded in other devices;
(5) a receiver, a terminal, an intelligent terminal, a cellular phone, a wireless device, a handset, a mobile unit, a vehicle-mounted device, a network device, a cloud device, an artificial intelligence device, etc.
(6) others and so on.

In a case that the communication device may be a chip or a chip system, reference may be made to a schematic block diagram of a chip shown in FIG. 9. The chip shown in FIG. 9 includes a processor 901 and an interface 902. One or more processors 901 may be arranged, and multiple interfaces 902 may be provided.

In a case that the chip is used to realize the functions of the terminal (such as the first sensing node in the aforementioned method embodiments) in the embodiments of the present disclosure, the interface 902 is configured to broadcast a discovery message to at least one second sensing node, where the discovery message carries sensing capability indication information, and the sensing capability indication information indicates a sensing capability of the first sensing node.

In some embodiments, the sensing capability indication information indicates at least one of the following sensing abilities: a sensing transmission capability, a sensing reception capability and a sensing data processing capability.

In some embodiments, the sensing capability of the first sensing node is determined by a hardware device of the first sensing node, or is determined through negotiation between the first sensing node and the network device.

In some embodiments, a way in which the first sensing node negotiates with the network device to determine the sensing capability includes: reporting a possessed sensing capability to the network device, and the possessed sensing capability is determined by the hardware device of the first sensing node; and receiving feedback information of the network device, where the feedback information indicates a sensing capability authorized by the network device or a sensing capability supported by the network device.

In some embodiments, the discovery message further carries at least one of: a source layer 2 address; a target layer 2 address; a discovery message type; a designated code indicating a service; and a security protection element.

In some embodiments, the source layer 2 address and the target layer 2 address are configured by the network device or by the first sensing node.

In a case that the chip is used to realize the functions of the terminal (such as the second sensing node in the aforementioned method embodiments) in the embodiments of the present disclosure, the interface 902 is configured to receive a discovery message broadcast by a first sensing node, where the discovery message carries sensing capability indication information, and the sensing capability indication information indicates a sensing capability of the first sensing node.

In some embodiments, the sensing capability indication information indicates at least one of the following sensing abilities: a sensing transmission capability, a sensing reception capability and a sensing data processing capability.

In some embodiments, the discovery message further carries at least one of: a source layer 2 address; a target layer 2 address; a discovery message type; a designated code indicating a service; and a security protection element.

In some embodiments, a target layer 2 address field of the second sensing node is configured by the second sensing node.

In some embodiments, a sensing capability of the second sensing node is determined by a hardware device of the second sensing node, or is determined through negotiation between the second sensing node and the network device.

In some embodiments, a way in which the second sensing node negotiates with the network device to determine the sensing capability includes: reporting a possessed sensing capability to the network device, where the possessed sensing capability is determined by the hardware device of the second sensing node; and receiving feedback information of the network device, where the feedback information indicates a sensing capability authorized by the network device or a sensing capability supported by the network device.

In some embodiments, in a case that the first sensing node and the second sensing node meet any one of the following conditions, it is determined to send a sensing service establishment request to the first sensing node: the first sensing node has a sensing transmission capability and the second sensing node has a sensing reception capability and a sensing data processing capability; the first sensing node has a sensing transmission capability and a sensing reception capability, and the second sensing node has a sensing data processing capability; the first sensing node has a sensing reception capability and a sensing data processing capability, and the second sensing node has a sensing transmission capability; and the first sensing node has a sensing data processing capability, and the second sensing node has a sensing transmission capability and a sensing reception capability.

In some embodiments, the chip further includes a memory 903 for storing necessary computer programs and data.

Those skilled in the art may also understand that various illustrative logical blocks and steps listed in the embodiments of the present disclosure may be implemented by electronic hardware, computer software, or a combination of both. Whether this function is realized by hardware or software depends on the specific application and the design requirements of the whole system. Those skilled in the art may use various methods to realize the described functions for each specific application, but this realization should not be understood to be beyond the scope of protection of the embodiments of the present disclosure.

Embodiments of the present disclosure also provide a communication system, which includes the communication device serving as the terminal (such as the first sensing node in the aforementioned method embodiments) and the communication device serving as the terminal (such as the second sensing node in the aforementioned method embodiments) in the aforementioned embodiment of FIG. 7, or the system includes the communication device serving as the terminal (such as the first sensing node in the aforementioned method embodiments) and the communication device serving as the terminal (such as the second sensing node in the aforementioned method embodiments) in the aforementioned embodiment of FIG. 8.

The present disclosure also provides a readable storage medium, on which instructions are stored, which, when executed by a computer, realize the functions of any one of the above method embodiments.

The present disclosure also provides a computer program product which, when executed by a computer, realizes the functions of any one of the above method embodiments.

The above embodiments may be realized in whole or in part by software, hardware, firmware or any combination thereof. When implemented by software, it may be in whole or in part implemented in the form of a computer program product. The computer program product includes one or more computer programs. When the computer program is loaded and executed on a computer, the flow or function according to the embodiment of the present disclosure is generated in whole or in part. The computer may be a general-purpose computer, a special-purpose computer, a computer network, or other programmable devices. The computer program may be stored in a computer-readable storage medium or transmitted from one computer-readable storage medium to another. For example, the computer program may be transmitted from a website, computer, server or data center to another website, computer or data center in a wired (such as a coaxial cable, an optical fiber, a digital subscriber line (DSL)) manner or in a wireless (such as infrared, wireless, microwave, etc.) manner. The computer-readable storage medium may be any available medium that a computer may access or a data storage device such as a server, a data center and the like that contains one or more available media integrated. The usable medium may be a magnetic medium (e.g., a floppy disk, a hard disk, a magnetic tape), an optical medium (e.g., a high-density digital video disc (DVD)), or a semiconductor medium (e.g., a solid state disk (SSD)) and the like.

It may be understood by those skilled in the art that ordinal numbers such as first and second involved in the present disclosure are only for the convenience of description, but are not used to limit the scope of the embodiments of the present disclosure, and also not used to indicate the sequence.

The term “at least one” in the present disclosure may also be described as one or more, and the term “a plurality of” may be two, three, four or more, which is not limited in the present disclosure. In the embodiments of the present disclosure, for a technical feature, the technical features in the technical feature are distinguished by “first”, “second”, “third”, “A”, “B”, “C” and “D”, etc., and there is no order of precedence or size between the technical features described by the “first”, “second”, “third”, “A”, “B”, “C” and “D”.

The corresponding relationships shown in the tables in the present disclosure can be configured or predefined. The values of the information in each table are only examples and can be configured as other values, which are not limited by the present disclosure. When configuring the corresponding relationship between the information and each parameter, it is not necessarily required to configure all the corresponding relationships illustrated in each table. For example, in the table in the present disclosure, the corresponding relationships shown in some rows may not be configured. For another example, appropriate deformation adjustments can be made based on the above table, such as splitting, merging, etc. The names of the parameters shown in the titles of the above tables can also use other names that can be understood by the communication device, and the values or representations of the parameters can also be other values or representations that can be understood by the communication device. When implementing the above tables, other data structures can also be used, such as arrays, queues, containers, stacks, linear lists, pointers, linked lists, trees, graphs, structures, classes, heaps, hash tables.

The predefinition in the present disclosure may be understood as definition, definition in advance, storage, pre-storage, pre-negotiation, pre-configuration, solidification, or pre-burning.

Those ordinary skilled in the art will appreciate that the units and algorithm steps of each example described in conjunction with the embodiments of the present disclosure can be implemented in electronic hardware, or a combination of computer software and electronic hardware. Whether these functions are performed in hardware or software depends on the specific application and design constraints of the technical solution. Professional and technical personnel can use different methods to implement the described functions for each specific application, but such implementation should not be considered to be beyond the scope of the present disclosure.

Those ordinary skilled in the art can clearly understand that, for the convenience and brevity of description, the specific working processes of the systems, devices and units described above can refer to the corresponding processes in the aforementioned method embodiments and will not be repeated here.

The above is only a specific embodiment of the present disclosure, but the protection scope of the present disclosure is not limited thereto. Those ordinary skilled in the art who are familiar with the technical field can easily think of changes or substitutions within the technical scope in the present disclosure, which should be included in the protection scope of the present disclosure. Therefore, the protection scope of the present disclosure should be based on the protection scope of the claims.

1. A sensing node discovery method, performed by a first sensing node, and comprising:
broadcasting a discovery message to at least one second sensing node,
wherein the discovery message carries sensing capability indication information, and the sensing capability indication information indicates a sensing capability of the first sensing node.

2. The method according to claim 1, wherein the sensing capability indication information indicates at least one of a sensing transmission capability, a sensing reception capability or a sensing data processing capability.

3. The method according to claim 1, wherein the sensing capability of the first sensing node is determined by a hardware device of the first sensing node, or is determined through negotiation between the first sensing node and a network device.

4. The method according to claim 3, wherein determining the sensing capability through the negotiation between the first sensing node and the network device comprises:
reporting a possessed sensing capability to the network device, wherein the possessed sensing capability is determined by the hardware device of the first sensing node; and
receiving feedback information of the network device, wherein the feedback information indicates at least one of a sensing capability authorized by the network device or a sensing capability supported by the network device.

5. The method according to claim wherein the discovery message further carries at least one of:
a source layer 2 address;
a target layer 2 address;
a discovery message type;
a designated code indicating a service; or
a security protection element.

6. The method according to claim 5, wherein the source layer 2 address and the target layer 2 address are configured by at least one of a network device or by the first sensing node.

7. The method according to claim 1, further comprising:
in a case that a sensing service establishment request of the at least one second sensing node is received, establishing a sensing service with the at least one second sensing node.

8. A sensing node discovery method, performed by a second sensing node, and comprising:
receiving a discovery message broadcast by a first sensing node,
wherein the discovery message carries sensing capability indication information, and the sensing capability indication information indicates a sensing capability of the first sensing node.

9. The method according to claim 8, wherein the sensing capability indication information indicates at least one of: a sensing transmission capability, a sensing reception capability or a sensing data processing capability.

10. The method according to claim 8, wherein the discovery message further carries at least one of:
a source layer 2 address;
a target layer 2 address;
a discovery message type;
a designated code indicating a service; or
a security protection element.

11. The method according to claim 8, further comprising:
in a case that a target layer 2 address carried in the discovery message does not match a target layer 2 address field of the second sensing node, discarding the discovery message.

12. The method according to claim 11, wherein the target layer 2 address field of the second sensing node is configured by the second sensing node.

13. The method according to claim 8, further comprising:
determining to send a sensing service establishment request to the first sensing node according to the sensing capability of the first sensing node and a sensing capability of the second sensing node, to establish a sensing service with the first sensing node.

14. The method according to claim 13, wherein the sensing capability of the second sensing node is determined by a hardware device of the second sensing node, or is determined through negotiation between the second sensing node and a network device.

15. The method according to claim 14, wherein determining the sensing capability of the second sensing node through the negotiation between the second sensing node and the network device comprises:
reporting a possessed sensing capability to the network device, wherein the possessed sensing capability is determined by the hardware device of the second sensing node; and
receiving feedback information of the network device, wherein the feedback information indicates at least one of a sensing capability authorized by the network device or a sensing capability supported by the network device.

16. The method according to claim 13, wherein in a case that the first sensing node and the second sensing node meet any at least one of the following conditions, it is determined to send the sensing service establishment request to the first sensing node:
the first sensing node has a sensing transmission capability, and the second sensing node has a sensing reception capability and a sensing data processing capability;
the first sensing node has a sensing transmission capability and a sensing reception capability, and the second sensing node has a sensing data processing capability;
the first sensing node has a sensing reception capability and a sensing data processing capability, and the second sensing node has a sensing transmission capability; or
the first sensing node has a sensing data processing capability, and the second sensing node has a sensing transmission capability and a sensing reception capability.

17. (canceled)

18. (canceled)

19. A communication device, comprising a processor and a memory, wherein the memory is configured to store a computer program, and the processor is configured to execute the computer program stored in the memory, to broadcast a discovery message to at least one second sensing node,
wherein the discovery message carries sensing capability indication information, and the sensing capability indication information indicates a sensing capability of a first sensing node.

20. A communication device, comprising a processor and a memory, wherein the memory is configured to store a computer program, and the processor is configured to execute the computer program stored in the memory, to cause the communication device to perform the method according to claim 8.

21. (canceled)

22. (canceled)

23. A computer-readable storage medium for storing instructions which, when executed, cause the method according to claim 1 to be performed.

24. A computer-readable storage medium for storing instructions which, when executed, cause the method according to claim 8 to be performed.
